(19) United States
(12) Patent Application Publication
(10) Pub. No.: US 2021/0373539 A1
(43) Pub. Date: Dec. 2, 2021

(54) METHOD FOR HANDLING A WORKPIECE, AND SYSTEM

(71) Applicant: HOMAG Automation GmbH, Lichtenberg (DE)

(72) Inventors: Jörg TIEDEMANN, Lamstedt (DE); Maximilian HELD, Dresden (DE)

(21) Appl. No.: 16/980,830

(22) PCT Filed: Mar. 13, 2019
(86) PCT No.: PCT/EP2019/056278

§ 371 Date: Sep. 14, 2020

(30) Foreign Application Priority Data
Mar. 14, 2018 (DE) 10 2018 203 880.5

(51) Int. Cl. G05B 19/418

(52) U.S. Cl. CPC G05B 19/4189; G05B 2219/31269

(57) ABSTRACT

The invention relates to a method for handling a workpiece and to a system. Such a method or system is used, for example, in the wood-processing industry, in particular the furniture and components industry. In particular, processing stations or processing machines can be linked or combined with one another.

### TECHNICAL FIELD

The invention relates to a method for handling a workpiece and to a system. Such a method or system is used, for example, in the wood-processing industry, in particular the furniture and components industry. In particular, processing stations or processing machines can be interlinked or combined with one another.

The said workpieces can be, in particular panel-shaped, workpieces made of wood, wood-based materials and/or composite materials. Examples of workpieces processed within the scope of the invention are kitchen worktops, furniture parts such as cabinet components, floor panels, doors or the like.

### STATE OF THE ART

In the furniture and components industry, depending on the complexity of production, multiple processing stations can be linked together, with a specific work step being carried out in each processing station. Since the processing machines of such processing stations operate at different speeds or the production time for a certain sub-step may differ from that of another processing machine due to varying complexity, workpieces may need to be buffered. In the case of panel-shaped workpieces, this can be achieved for example by stacking the workpieces and bridging sections between processing stations or between a processing machine and a workpiece storage area by means of stacking roller conveyors, cross transfer platforms, angle transfers, lifting tables, belt conveyors, chain conveyors or conveyor belts.

The transport machines commonly used in the furniture and components industry are permanently installed in the production hall and therefore cannot be moved from one place to another. It is often necessary to secure the transport machines with protective barriers to prevent access by persons. The area occupied by the transport machine is thus blocked, even when the transport machine is not in use. If a transport machine fails, this can cause a stoppage of the entire system.

The rigid interlinking of processing stations requires forward-looking production planning, which is reflected among other things in the so-called stacking order. If changes are made during the production process, this sometimes leads to considerable delays, as the sequence of workpieces to be processed must be resorted through restacking processes. This leads to a reduction in overall system performance.

Especially given the increasing demands for the individual production of furniture parts or components, this situation cannot be fully addressed using known measures.

### SUBJECT MATTER OF THE INVENTION

The inventors set themselves the object of providing a method and a system for handling workpieces that allow increased flexibility in production.

Claim 1 provides a corresponding method. Other preferred embodiments are presented in the dependent claims.

An idea of the invention is to provide a method and system whereby workpieces are transported by means of a driverless transport vehicle with which one or more workpieces can be picked up, transported and deposited. To this end, the driverless transport vehicle can be equipped with a workpiece carrier that allows random access to one or more workpieces. In addition, random access by the driverless transport vehicle to the workpiece carriers can be enabled, for example, through a suitable arrangement and storage/buffering of the workpiece carriers.

The driverless transport vehicle can transport one or more workpieces. In the case of multiple workpieces, these can be transported as a horizontal stack of panels, vertically positioned stacks of panels, individual panels, form-milled individual pieces in a common layer (nesting), pre-assembled furniture parts or similar.

Moreover, the driverless transport vehicle can also be used to transport sub-components or assembly parts such as screws or similar, auxiliary and operating materials, packaging materials, adhesives, coating materials such as edge strips, hinges, etc.

The method according to the invention is directed at depositing the workpiece or workpieces or a workpiece carrier at a storage location of a storage area. The storage location should allow random access. Random access means that the workpiece(s) or the workpiece carrier can be retrieved from the storage location, with the accessibility of the storage location being guaranteed. In particular, it is provided that accessibility by a driverless transport vehicle is guaranteed. For example, the driverless transport vehicle can drive under one or more, possibly stacked, workpieces in the area of a storage location and pick it or them up.

The driverless transport vehicle can pick up one or more workpieces. Alternatively or additionally, the transport vehicle is equipped to receive a workpiece carrier, which can, for example, pick up or hold one or more workpieces.

The driverless transport vehicle can be that which deposited the workpiece(s) or the workpiece carrier at the storage location, or it can be another driverless transport vehicle.

A method for handling a workpiece, in particular a panel-shaped workpiece, is presented, which method involves the steps of: generating a transport request and selecting a first driverless transport vehicle from a plurality of driverless transport vehicles, and picking up and transporting the workpiece or the plurality of workpieces with the first driverless transport vehicle, the workpiece or workpieces being deposited at a storage location of a storage area, which storage location allows random access.

The use of the driverless transport vehicle has the advantage that it is also possible to transport the workpiece(s) into secured processing stations without stopping processing within the corresponding cell. Another advantage is that the failure of a driverless transport vehicle does not cause a stoppage of the entire system. A further advantage is that the storage or buffer area is no longer fully enclosed by, for example, protective barriers and blocked for other uses.

The dimensioning of the storage area is preferably variable. Since the storage or buffer area can be changed dynamically, it can also be temporarily modified for other production purposes or used in other ways.

An embodiment of the invention provides that the storage area has one or more buffer zones, the one or more buffer zones each comprising one or more storage locations, the dimensioning of the buffer zone or buffer zones preferably being variable. This allows advantageous sequencing of the workpieces to be temporarily stored or buffered.

One or more processing stations are preferably provided, the processing station or stations preferably comprising a panel dividing system, a processing machine for wooden workpieces, a sorting cell, an assembly machine or a workpiece transport apparatus.

In a variant, a transport request can be generated by means of a cell controller that communicates with a fleet control system.

A transport route and/or a transport speed can be defined based on a prioritisation of the transport request and/or on a load weight of the first driverless transport vehicle. This allows rapid replacement of any missing workpieces that have been removed in the course of quality control.

A prioritisation of the transport request is preferably changed or the transport request cancelled. It is therefore possible to actively influence the production process.

Furthermore, it can be provided that a transport request is generated for a second or additional driverless transport vehicle, the priority of the transport request being set higher or lower than the priority of the transport request of the first driverless transport vehicle. This provides an extremely flexible system.

It is preferable that the workpiece is at least partially comprised of wood, wood-based material and/or composite material. Especially in the woodworking industry, a flexible system is advantageous in order to be able to respond to varying requests.

In one embodiment, the method can be carried out in such a way that the driverless transport vehicle drives under the workpiece or, possibly stacked, workpieces, in order to pick up one or more workpieces from the stacking location, and picks up the workpiece or workpieces. In particular, the workpiece or workpieces are held in a workpiece carrier.

The invention further relates to a system (or a plant or production facility) comprising a plurality of driverless transport vehicles, the system being adapted to generate a transport request and to select a first driverless transport vehicle from the plurality of driverless transport vehicles, and the system comprising a storage area with one or more storage locations, which storage location allows random access.

The same or similar advantages can be achieved with such a system as with the method described above.

The system preferably comprises a control unit with a cell controller and a subordinate fleet control system, the cell controller being adapted to define a transport request based on a state of the system and/or based on a request from a higher-level resource planning system.

An embodiment of the invention provides that the driverless transport vehicles are autonomously driving units which are in particular electrically operated. This allows a high degree of flexibility. Furthermore, errors in the handling and transport of workpieces can be avoided. Such a system is therefore able to work extremely efficiently.

The system can have at least one processing station for processing workpieces, preferably several processing stations, the processing station preferably comprising a panel dividing system, a processing machine for wooden workpieces, a sorting cell, an assembly machine or a workpiece transport apparatus.

The system can be adapted to define a transport route and/or a transport speed of the driverless transport vehicle based on a prioritisation of the transport request and/or on a loading weight of the driverless transport vehicle. This allows rapid replacement of any missing workpieces that have been removed in the course of quality control.

The driverless transport vehicle can be adapted to drive under one or more, possibly stacked, workpieces and pick it or them up. The workpiece is or the workpieces are preferably provided in a workpiece carrier.

According to a further object of the invention, the invention concerns an arrangement of several, in particular different, woodworking machines and one or more driverless transport vehicles. To meet this object, the above-mentioned aspects of the method or system can be used individually or in combination.

### BRIEF DESCRIPTION OF THE DRAWINGS

FIG. 1 is a schematic view of a workpiece handling system.

FIG. 2 graphically illustrates the control unit implemented in the system according to FIG. 1.

### DETAILED DESCRIPTION OF THE PREFERRED EMBODIMENTS

The invention will be explained in more detail with reference to the attached figures which show an exemplary embodiment of the invention, but do not limit the subject matter of the invention. The modifications described below of certain features of the described embodiment may be combined with other features or modifications of the embodiment to form further embodiments of the invention.

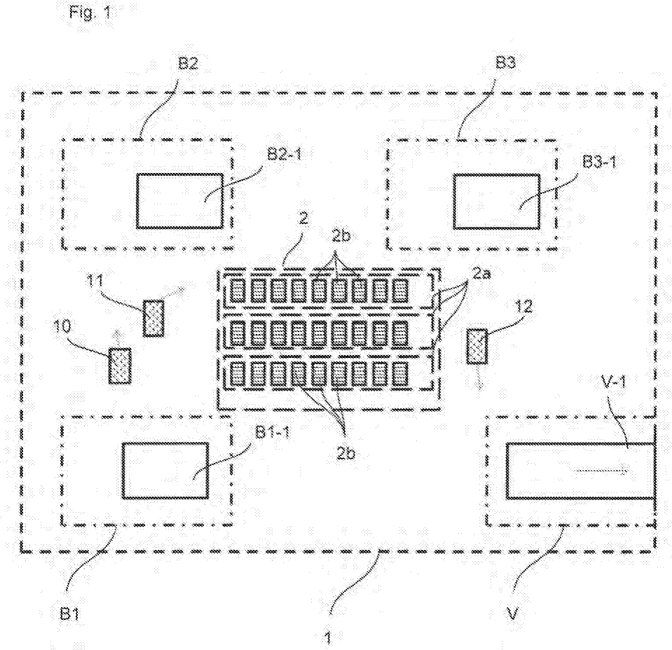

FIG. 1 shows a schematic view of a system 1, in which workpieces can be processed and buffered, the type and number of stations being exemplary. The illustrated system 1 is provided in particular for the processing and machining of panel-shaped workpieces produced in the furniture and components industry. In particular, these are wooden workpieces, workpieces made of wood-based materials, workpieces made of composite materials or similar.

The system 1 is defined, for example, by the confines of a production hall, but can also include parts of such a production hall. System 1 provides for machining stations B1-B3, which are spaced apart from one another within the area of the system 1.

The processing stations B1-B3 can be secured against unauthorised access by a barrier. Alternatively, it is possible to mark an area of a processing station with suitable floor markings.

A processing machine B1-1, B2-1 and B3-1 is disposed in each of the processing stations B1-B3. If, according to a modification, the processing station is not placed behind a barrier, the processing station in question can also be defined by the processing machine itself

The system 1 also includes a storage or buffer area 2, which is provided as “free space” in the system 1. However, the storage area 2 is not defined by a specific dimension, but can be variably adjusted. This means that the control unit described below of the system 1 can define and change the storage area 2 as required.

A plurality of buffer zones 2a are provided in the storage area 2, which, according to the embodiment shown in FIG. 1, form elongated sections within the storage area 2. Three buffer zones are shown by way of example, the number and dimensioning of the buffer zones being variable.

A plurality of storage locations/stacking locations 2b are defined in the buffer zones. The storage locations are positions in the storage area 2 of the system 1, at which one or more workpieces can be deposited and stored with or without a carrier.

The control unit of the system defines the storage or buffer area 2, the buffer zones 2a and the storage locations 2b and can dynamically change them if necessary during operation of the system. If, for example, a smaller storage area 2 is required due to current production and lower demand for workpiece buffering, it is possible, for example, to release a buffer zone 2a or make it smaller in order to adjust the dimensioning of the storage area 2.

The storage area/buffer area may have aisles between the buffer sections 2b, in which a driverless transport vehicle can move in order to randomly access all stacks in the area 2b directly. In the case of buffer sections 2b where this is not possible due to spatial conditions, the driverless transport vehicle can randomly access stacks by picking up stacks in the buffer section 2b at the end of the section and depositing them in a suitable position.

The described embodiment example of the system 1 also includes a packing station V, which includes a packing machine V-1. The packing station V defines, as it were, a final processing step in which workpieces processed with one or more of the above-mentioned processing machines are combined and packed as appropriate. According to a further embodiment, the system can also be realised without a packing station.

A plurality of driverless transport vehicles 10-12 are provided in the production plant, wherein the driverless transport vehicles 10-12 are electrically operated. The driverless transport vehicles are adapted to pick up one or more workpieces and, for example, unload them at one of the storage locations 2b. For this purpose, the driverless transport vehicles are able to drive under a stack of workpieces and lift it, if several workpieces stacked on top of each other are held at one of the storage locations. The number of three driverless transport vehicles shown in the embodiment is purely exemplary. The number of transport vehicles can be varied as required.

The driverless transport vehicles 10-12 are adapted to transport one or more workpieces on a workpiece carrier. Furthermore, the driverless transport vehicles 10-12 are adapted to pick up the workpieces from a specific processing machine and transfer the transported workpieces according to a transport request. The driverless transport vehicles 10-12 are freely movable within the system 1.

If, for example, a workpiece processed in processing station B1 is not transferred directly to another processing station, the workpiece processed by processing station B1 can be buffered or temporarily stored in the storage area 2. For this purpose, the workpiece to be temporarily stored is moved to one of the storage locations 2b by means of a driverless transport vehicle and set down.

Since the storage locations 2b are disposed in an accessible way, it is not necessary to adhere to a certain retrieval sequence or to carry out restacking operations, as is the case with conventional stacking roller conveyors. Instead, a driverless transport vehicle can access a specific storage location 2b, so that the processing sequence between stations of the system 1 can be changed in a flexible manner.

In particular, it is possible to assign a higher priority to a specific request or to change this priority. If, for example, it is detected in processing station B2 that a sub-operation on a workpiece has been performed incorrectly and hence it is necessary to carry out rework on the workpiece, further part workpieces can be deposited in storage area 2 and the part workpiece to be replaced can be reworked and conveyed to processing station B2 with increased priority. For this purpose, the corresponding driverless transport vehicle receives a prioritised transport request.

Alternatively, it is possible to remove a part workpiece already in storage area 2 by means of one of the driverless transport vehicles and take it to the processing station B2. Since the storage locations are accessible, a driverless transport vehicle can freely access the corresponding part workpiece in the storage area 2.

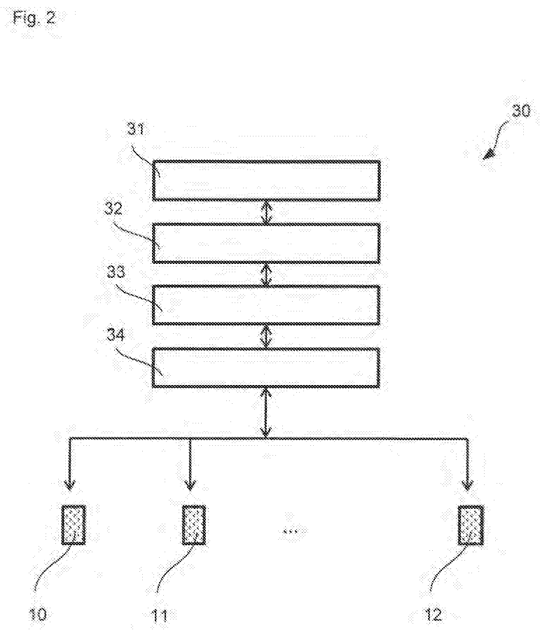

To illustrate the control system for the driverless transport vehicles 10-12, reference is made to the schematic diagram in FIG. 2. The control unit 30 incorporates a resource planning system 31 which carries out higher-level production planning.

A cell controller 32 is subordinate to the resource planning system 31. It receives production requests for different processing machines from the resource planning system 31, actions individual transport requests for the processing machines and processes the transport requests with one or more driverless transport vehicles, if necessary in combination with optionally available conventional transport mechanisms. The cell controller 32 is equipped with a database system, a user interface with visualisation, suitable interfaces to the resource planning system 31 and interfaces to cloud services and mobile devices.

The cell controller 32 has the task of assigning one or more driverless transport vehicles 10-12 from different production areas depending on the workload of the individual production areas and, where appropriate, dynamically moving the driverless transport vehicles to other production areas. The driverless transport vehicles 10-12 in the system can also be assigned a transport request depending on the prioritisation, setting the transport route and/or the transport speed according to the prioritisation.

Prioritisation in this context means that a particular transfer request is assigned a lower or higher priority within the system. In this way, it is possible to compensate for production fluctuations of the processing machines through corresponding inward and outward transport of workpieces, taking the prioritisation into account.

The driverless transport vehicles are equipped with sensors to detect workpiece parameters and possible congestion situations in the area of the transport route and transmit this information to the cell controller.

The cell controller 32 is connected via a coupling system 33 to a fleet control system 34, which selects a specific driverless transport vehicle and transmits specific control commands to the driverless transport vehicles 10-12. The fleet control system 34 also monitors the plant in such a way that no blockages occur if multiple driverless transport vehicles obstruct one another.

The driverless transport vehicles 10-12 have appropriate sensor technology to detect loaded or unloaded workpiece carriers and also to identify the workpiece carrier. If, for example, larger workpiece carriers are picked up, it may be necessary to increase the size of a safety area around the driverless transport vehicle.

According to another variant, the driverless transport vehicles 10-12 can each be equipped with a detection device to identify individual workpieces. The detection device can, for example, be designed as a barcode scanner or RFID scanner to recognise a barcode or RFID chip attached to a workpiece.

Furthermore, the driverless transport vehicles can take over workpieces or stacks of workpieces from the processing machines B1-1, B2-1 and B3-1 or from optionally available transport machines. The workpieces or stacks of workpieces can be picked up in a flexible manner and transferred to another processing station, a storage location 2b of the storage area 2 or an optionally available transport machine.

Depending on the stability of the workpieces, speed profiles can be set for the driverless transport vehicles. In particular, it is possible to implement a higher transport speed if the workpieces are relatively insensitive. If, for example, parts are manufactured using a nesting process, it may be advisable to run at a lower conveying speed in order to prevent part workpieces from falling from the workpiece carrier or being moved onto the workpiece carrier if the driverless transport vehicle stops abruptly.

Driverless transport vehicles have the advantage that it is also possible to transport the workpiece(s) to secured processing stations without stopping processing within the corresponding cell. For this purpose, for example, a portal can be provided in the enclosure/protective barrier of the corresponding processing cell. The portal can be opened and closed by interacting with a corresponding sensor system of the driverless transport vehicle.

Another advantage compared to the state of the art is that the failure of a driverless transport vehicle does not cause a stoppage of the entire system. The same applies in the event of failure of a machining station B1-B3, if, for example, a workpiece can be processed in multiple processing stations.

A further advantage over the state of the art is that the storage or buffer area 2 is no longer completely protected by, for example, protective barriers and blocked for other uses. Since the storage or buffer area 2 can be changed dynamically, it can also be temporarily modified for other production purposes. Moreover, the storage or buffer area 2 is no longer surrounded by a barrier and the area or travel paths can also be used by forklift trucks, for example.

### LIST OF REFERENCE NUMBERS

1 Production plant/system
2 Variable storage area
2a Buffer zone
2b Storage location
B1 First processing station
B1-1 First processing machine
B2 Second processing station
B2-1 Second processing machine
B3 Third processing station
B3-1 Third processing machine
V Packing station
V-1 Packing machine
10 First driverless transport vehicle
11 Second driverless transport vehicle
12 Third driverless transport vehicle
30 Control unit
31 Resource planning system
32 Cell controller
33 Coupling system
34 Fleet control system

1. Method for handling a workpiece, in particular a panel-shaped workpiece, which involves the steps of:
generating a transport request and selecting a first driverless transport vehicle (10) from a plurality of driverless transport vehicles (10, 11, 12),
picking up and transporting the workpiece, a plurality of workpieces or a workpiece carrier with the first driverless transport vehicle (10), the workpiece, the workpieces or the workpiece carrier being deposited at a storage location (2b) of a storage area (2), which storage location (2b) allows random access.

2. Method according to claim 1, characterised in that the dimensioning of the storage area (2) is variable.

3. Method according to claim 1 or 2, characterised in that the storage area (2) has one or more buffer zones (2a), the one or more buffer zones (2a) each comprising one or more storage locations (2b), the dimensioning of the buffer zone (2a) or buffer zones (2a) being preferably variable.

4. Method according to one of the preceding claims, characterised in that one or more processing stations (B1-1, B2-1, B3-1) are provided, the processing station (B1-1, B2-1, B3-1) or processing stations (B1-1, B2-1, B3-1) preferably comprising a panel dividing system, a processing machine for wooden workpieces, a sorting cell, an assembly machine or a workpiece transport apparatus.

5. Method according to one of the preceding claims, characterised in that a transport request is generated by means of a cell controller (32) communicating with a fleet control system (34).

6. Method according to one of the preceding claims, characterised in that a transport route and/or a transport speed can be defined based on a prioritisation of the transport request and/or on a load weight of the first driverless transport vehicle (10).

7. Method according to one of the preceding claims, characterised in that a prioritisation of the transport request is changed or the transport request is cancelled.

8. Method according to one of the preceding claims, characterised in that a transport request is generated for a second or additional driverless transport vehicle (11), the priority of the transport request being set higher or lower than the priority of the transport request of the first driverless transport vehicle (11).

9. Method according to one of the preceding claims, characterised in that the workpiece is at least partially comprised of wood, wood-based material and/or composite material.

10. Method according to one of the preceding claims, characterised in that the driverless transport vehicle (10) drives under the workpiece or, possibly stacked, workpieces, in order to pick up one or more workpieces or a workpiece carrier from the stacking location (2b), and picks up the workpiece or workpieces.

11. System (1) for handling workpieces, comprising:
a plurality of driverless transport vehicles (10, 11, 12),
the system (1) being adapted to generate a transport request and to select a first driverless transport vehicle (10) from the plurality of driverless transport vehicles (10, 11, 12),
the system (1) comprising a storage area (2) with one or more storage locations (2b), which storage location (2b) allows random access.

12. System (1) according to claim 11, characterised in that the system comprises a control unit (30) with a cell controller (32) and a subordinate fleet control system (34), the cell controller being adapted to define a transport request based on a state of the system (1) and/or based on a request from a higher-level resource planning system (31).

13. System (1) according to claim 11 or 12, characterised in that the driverless transport vehicles are autonomously driving units which are in particular electrically operated.

14. System according to one of claims 11-13, characterised in that the system comprises at least one processing station for processing workpieces, the processing station (B1-1, B2-1, B3-1) preferably comprising a panel dividing system, a processing machine for wooden workpieces, a sorting cell, an assembly machine or a workpiece transport apparatus.

15. System according to one of claims 11-14, characterised in that system (1) is adapted to define a transport route and/or a transport speed of the driverless transport vehicle (10) based on a prioritisation of the transport request and/or on a loading weight of the driverless transport vehicle (10).

16. System according to one of claims 11-15, characterised in that the driverless transport vehicle (10) is adapted to drive under one or more, possibly stacked, workpieces and to pick up said workpiece or workpieces.
